(19) United States
(12) Patent Application Publication
(10) Pub. No.: US 2003/0080602 A1
(43) Pub. Date: May 1, 2003

(54) Easy-to-assemble armrest for a large chair

(76) Inventor: Hsiu-Hsueh Wu, Ta Li City (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/000,055

(22) Filed: Nov. 1, 2001

(51) Int. Cl. B60N 2/46

(52) U.S. Cl. 297/411.46

(57) ABSTRACT

An armrest comprises two limbs. At least one of the limbs has a compartment or recess. An arm pad or lid is mounted to cover the compartment or recess. The arm pad or lid has at least one peg for releasably engaging with at least one engaging hole in a wall defining the compartment or the recess.

### BACKGROUND OF THE INVENTION

1. Field of the Invention

The present invention relates to an easy-to-assemble armrest for a large size chair.

2. Description of the Related Art

Most office chairs have armrests to support the forearms of the user. In order to provide secure engagement to the seat and the backrest, the armrests of a large size office chair is often made of metal. FIGS. 6 through 8 of the drawings illustrate a conventional armrest for a large size office chair. The armrest comprises an integral hollow armrest frame 1′ having plural holes 11′ and 12′ for assembly purpose. A rigid engaging plate 2′ comprises a shield portion 21′ for shielding the hollow portion 14′ of the armrest frame 1′ and in engaging portion 22′ that is engaged with the armrest frame 1′ by fasteners 24′ that extend through holes 13′ in the armrest frame 1′ and holes 23′ in the engaging portion 22′. A covering member 3′ composed of a soft pad 31′ and a covering 32′ is provided to enclose the armrest frame 1′ and the engaging plate 2′. The engaging plate 2′ and the armrest frame 1′ are manufactured separately in order to reduce the weight of the engaging plate 2′ made of metal. Thus, separate molds for the engaging plate 2′ and the armrest frame 1′ are required, which result in an increase in the overall cost. In addition, the enclosing of the armrest frame 1′ and the engaging plate 2′ by the covering member 3′ and the assembly between the armrest frame 1′ and the engaging plate 2′ by fasteners are time consuming.

### SUMMARY OF THE INVENTION

An object of the present invention is to provide an easy-to-assemble armrest for a large size chair while achieving the purpose of reducing the weight of the metal armrest.

In accordance with one aspect of the invention, an armrest comprises a first limb and a second limb. The first limb comprises a compartment defined in an upper side thereof. The compartment has an opening and is delimited by a bottom wall. At least one engaging member is mounted on the bottom wall and has an engaging hole. An arm pad is mounted to cover the compartment. The arm pad has at least one peg extending downward from an underside thereof for releasably engaging with the engaging hole of the engaging, member of the first limb.

In accordance with a second aspect of the invention, an armrest comprises a first limb and a second limb. The second limb comprises two lateral sides, each having a recess defined therein. The recesses are separated from each other by a separation wall that has at least two engaging holes defined therein. Two lids are respectively mounted to cover the recesses. Each lid comprises at least one peg projecting from a side thereof for releasably engaging with an associated one of the engaging holes in the separation wall.

In accordance with a third aspect of the invention, an armrest comprises a first limb and a second limb. The second limb comprises two lateral sides. At least one of the lateral sides has a recess defined therein. At least one engaging hole is defined in a bottom wall defining the recess. A lid is mounted to cover the recess. The lid comprises at least one peg projecting from a side thereof for releasably engaging with the engaging hole.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an armrest in accordance with the present invention.

FIG. 2 is an exploded perspective view of the armrest in accordance with the present invention.

FIG. 3 is a top view, partly sectioned, of the armrest in accordance with the present invention.

FIG. 4 is a side view, partly sectioned, of the armrest in accordance with the present invention.

FIG. 5 is a perspective view of a chair with the armrest in accordance with the present invention.

FIG. 6 is a perspective view of a conventional armrest.

FIG. 7 is an exploded perspective view of the conventional armrest.

FIG. 8 is a sectional view taken along plane 8-8 in FIG. 6..

### DETAILED DESCRIPTION OF THE PREFERRED EMBODIMENT

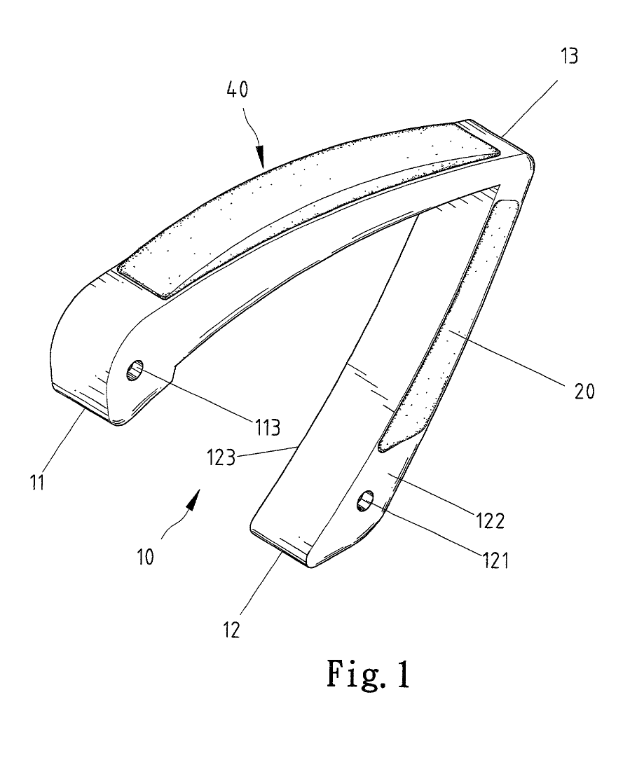

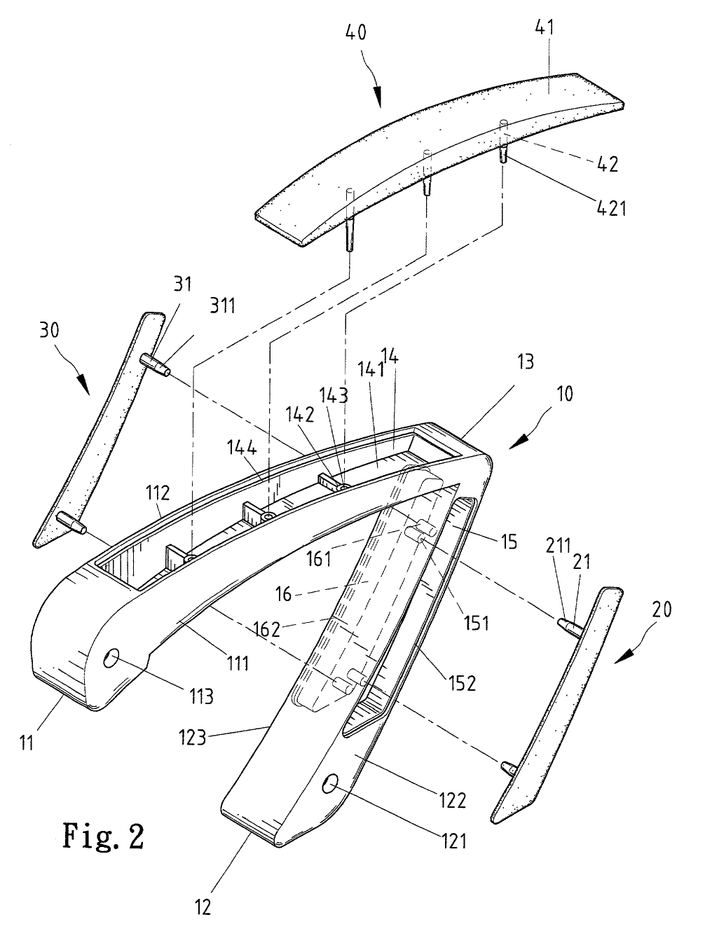

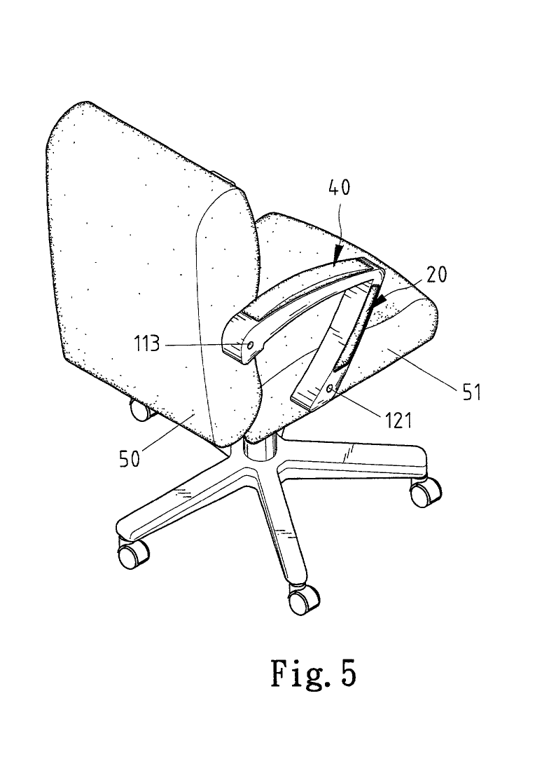

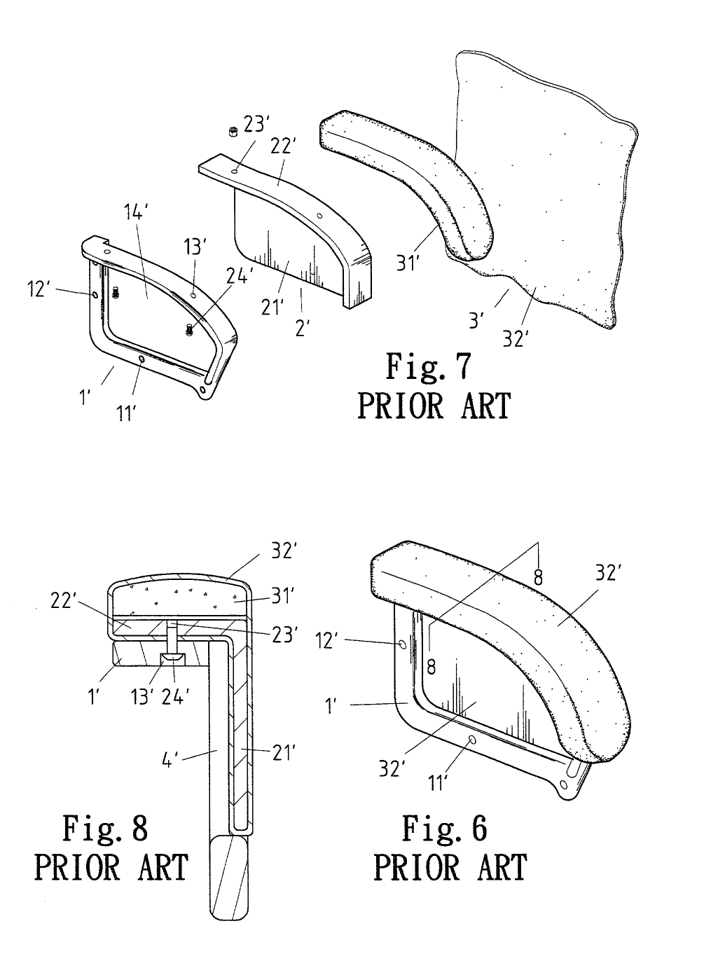

Referring to FIGS. 1 through 5 and initially to FIGS. 1 and 2, an armrest 10 in accordance with the present invention is substantially V-shaped and comprises a first limb 11 and a second limb 12 that is connected to the first limb 11 at a joint section 13. The first limb 11 comprises two lateral sides 111 and 112 between which a compartment 14 is defined. The compartment 14 has an upper opening and is delimited by a bottom wall 141. Namely, the compartment 14 is defined in an upper side of the first limb 11. A ledge 144 is formed on an upper end of the compartment 14. At least one engaging member 142 is mounted on the bottom wall 141 and has an engaging hole 143. An engaging hole 113 is defined in a distal end (not labeled) of the first limb 11 for connection with a side of a backrest 50 (FIG. 5) of a chair.

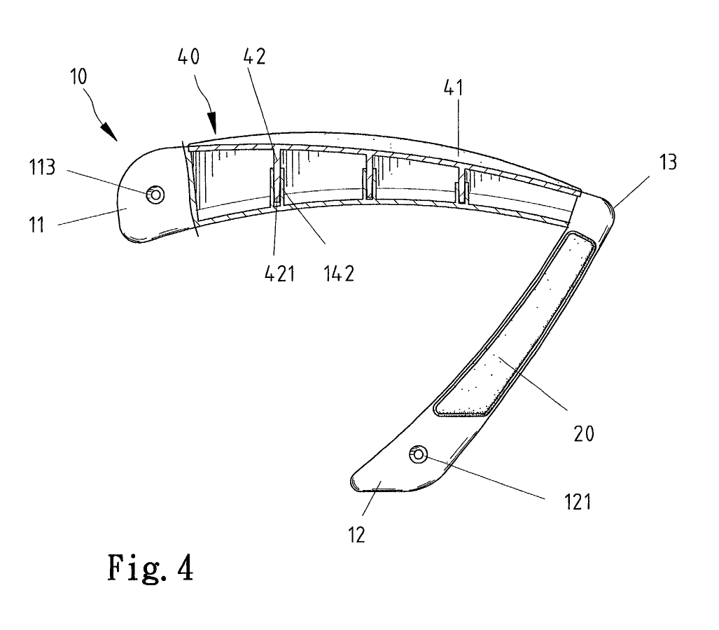

An arm pad 40 is mounted to cover the compartment 14. In an embodiment, the arm pad 40 is a pad 41 having at least one peg 42 extending downward from an underside thereof. The peg 42 has a tapered end 421 for tightly, releasably engaging with the engaging hole 143 of the engaging member 142, best shown in FIG. 4. The arm pad 40 rests on the ledge 144 of the first limb 11 after assembly, such that an outer face of the arm pad 40 is flush with the upper side of the first limb 11. Thus, the arm pad 40 can be mounted to or detached from the first limb 11 of the armrest 10 without any screws or bolts.

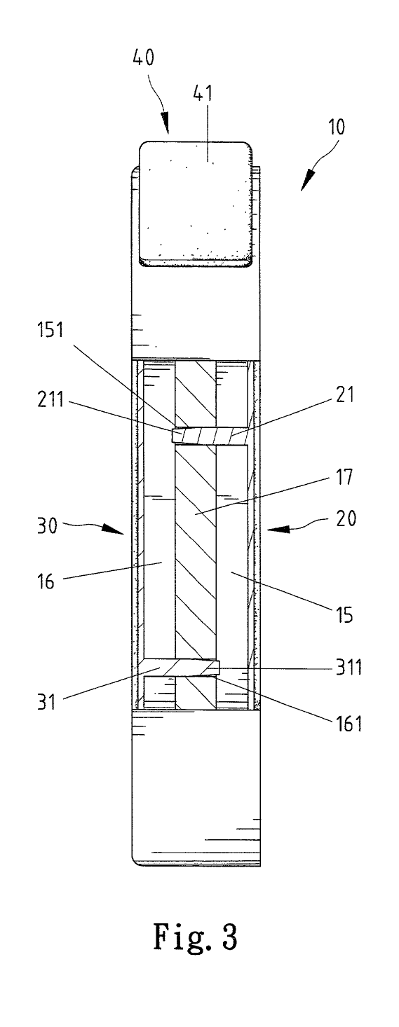

The second limb 12 comprises two lateral sides 122 and 123 (FIG. 2) each having a recess 15, 16 defined therein. A ledge 152, 162 is formed in each recess 15, 16. The recesses 15 and 16 are separated from each other by a separation wall 17 (FIG. 3) that has at least two engaging holes 151 and 161 defined therein. An engaging hole 121 is defined in a distal end (not labeled) of the second limb 12 for connection with a side of a seat 51 (FIG. 5) of the chair.

Two lids 20 and 30 are respectively mounted to cover the recesses 15 and 16. Each lid 20, 30 comprises at least one peg 21, 31 projecting from a side thereof. The peg 21, 31 has a tapered end 211, 311 for tightly, releasably engaging with the respective engaging hole 151, 161 in the separation wall 17, best shown in FIG. 3. Each lid 20, 30 abuts against on the ledge 152, 162 of the second limb 12 after assembly, such that an outer face of the each lid 20, 30 is flush with the respective lateral side of the second limb 12. Thus, the lids 20 and 30 can be mounted to or detached from the second limb 12 of the armrest 10 without any screws or bolts. In this embodiment, the separation wall 17 has two engaging holes 151 and 161 defined in each of two ends thereof, and each lid 20, 30 has two pegs 21, 31. The engaging holes 151 and 161 in each end of the separation wall 17 are located at the same level, best shown in FIG. 3.

In an alternative embodiment of the invention, only one lid 20 or 30 (e.g., lid 20) and only one recess 15 or 16 (e.g., recess 15) are provided. Namely, one of the lateral sides of the second limb 12 has a recess 15 defined therein. At least one engaging hole 151 is defined in a bottom wall defining the recess 15. A lid 20 is mounted to cover the recess 15 and comprises at least one peg 21 projecting from a side thereof. The peg 21 has a tapered end 211 for releasably engaging with the engaging hole 211.

The armrest 10 is generally made of alloy or plastic, and it is generally used with a large size chair. The provision of the compartment 14 and the recesses 15 and 16 is to reduce the weight of the armrest 10 and thus save the cost. The resultant armrest is aesthetically pleasing, and the assembly procedure is easy. Manufacture of the second limb 12 is also easy, as it is symmetrically constructed by means of providing identical distance between the engaging holes 151 and 161 in each end of the separation wall 17 and providing regular interval between the pegs 21, 31. Further, the arm pad 40 and the lids 20 and 30 can be respectively mounted to or detached from the first limb 11 and the second limb 12 of the armrest 10 without any screws or bolts.

Although the invention has been explained in relation to its preferred embodiment, it is to be understood that many other possible modifications and variations can be made without departing from the scope of the invention as hereinafter claimed.

What is claimed is:

1. An armrest comprising:
a first limb and a second limb, the first limb comprising a compartment defined in an upper side thereof, the compartment having an opening and being delimited by a bottom wall, at least one engaging member being mounted on the bottom wall and having an engaging hole; and
an arm pad mounted to cover the compartment, the arm pad having at
least one peg extending downward from an underside thereof, said at least one peg releasably engaging with the engaging hole of said at least one engaging member of the first limb.

2. The armrest as claimed in claim 1, wherein the first limb comprises a ledge defined in the compartment, and wherein the arm pad abuts against the ledge of the first limb such that an outer face of the arm pad is flush with the upper side of the first limb.

3. The armrest as claimed in claim 1, wherein said at least one peg has a tapered end for tightly, releasably engaging with the engaging hole of said at least one engaging member of the first limb.

4. The armrest as claimed in claim 1, wherein the second limb comprises two lateral sides each having a recess defined therein, the recesses being separated from each other by a separation wall that has at least two engaging holes defined therein, further comprising two lids that are respectively mounted to cover the recesses, each said lid comprising at least one second peg projecting from a side thereof, said at least one second peg releasably engaging with an associated one of said at least two engaging holes in the separation wall.

5. The armrest as claimed in claim 4, wherein the second limb has a second ledge formed in each said recess, and wherein each said lid abuts against an associated one of the second ledges of the second limb such that an outer face of each said lid is flush with an associated one of the lateral sides of the second limb.

6. The armrest as claimed in claim 4, wherein said at least one second peg has a tapered end for tightly, releasably engaging with the associated one of the engaging holes in the separation wall.

7. An armrest comprising a first limb and a second limb, the second limb comprising two lateral sides each having a recess defined therein, the recesses being separated from each other by a separation wall that has at least two engaging holes defined therein, further comprising two lids that are respectively mounted to cover the recesses, each said lid comprising at least one peg projecting from a side thereof, said at least one peg releasably engaging with an associated one of the engaging holes in the separation wall.

8. The armrest as claimed in claim 7, wherein the second limb has a ledge formed in each said recess, and wherein each said lid abuts against an associated one of the ledges of the second limb such that an outer face of each said lid is flush with an associated one of the lateral sides of the second limb.

9. The armrest as claimed in claim 7, wherein said at least one peg has a tapered end for tightly, releasably engaging with the associated one of the engaging holes in the separation wall.

10. An armrest comprising a first limb and a second limb, the second limb comprising two lateral sides, at least one of the lateral sides having a recess defined therein, at least one engaging hole being defined in a bottom wall defining the recess, further comprising a lid that is mounted to cover the recess, said lid comprising at least one peg projecting from a side thereof for releasably engaging with said at least one engaging hole.

11. The armrest as claimed in claim 10, wherein the second limb has a ledge formed in said recess, and wherein said lid abuts against the ledge of the second limb such that an outer face of each said lid is flush with an associated one of the lateral sides of the second limb.

12. The armrest as claimed in claim 10, wherein said at least one peg has a tapered end for tightly, releasably engaging with said at least one engaging hole.
